(19) United States
(12) Patent Application Publication
(10) Pub. No.: US 2015/0042580 A1
(43) Pub. Date: Feb. 12, 2015

(54) MOBILE TERMINAL AND A METHOD OF CONTROLLING THE MOBILE TERMINAL

(71) Applicant: LG ELECTRONICS INC., Seoul (KR)

(72) Inventors: Hongjo Shim, Seoul (KR); Seonghyok Kim, Seoul (KR); Jinhyoung Park, Seoul (KR); Hyejin Eum, Seoul (KR)

(73) Assignee: LG Electronics Inc.

(21) Appl. No.: 14/341,331

(22) Filed: Jul. 25, 2014

(30) Foreign Application Priority Data
Aug. 8, 2013 (KR) 10-2013-0094235
Aug. 19, 2013 (KR) 10-2013-0098045

(51) Int. Cl. G06F 3/01; G06F 3/0488; G06F 3/0486; G06F 3/041

(52) U.S. Cl. CPC G06F 3/017; G06F 3/0416; G06F 3/04883; G06F 3/0486
USPC 345/173

(57) ABSTRACT

Provided is a mobile terminal including: a display unit to which a touch input is applied to produce a first control command to control the mobile terminal; a proximity sensor; a gesture sensor; a proximity touch sensor; and a controller that produces a second control command different from the first control command when the proximity sensor, the gesture sensor, and the proximity touch sensor sense an object in front of the display unit in this sequence and then the gesture sensor senses a predetermined first gesture, in which the proximity sensor, the gesture sensor, and the proximity touch sensor are different in object-recognizable distance.

### CROSS-REFERENCE TO RELATED APPLICATION

Pursuant to 35 U.S.C. §119(a), this application claims the benefit of earlier filing date and right of priority to Korean Application No. 10-2013-0094235, filed on Aug. 8, 2013 and No. 10-2013-0098045 filed on Aug. 19, 2013, the contents of which is incorporated by reference herein in its entirety.

### BACKGROUND OF THE DISCLOSURE

1. Field of the Disclosure

The present technology disclosed in the present specification relates to a mobile terminal and a method of controlling the mobile terminal.

2. Background of the Disclosure

Generally, a mobile terminal (portable electronic apparatus) is a portable apparatus that is equipped with at least one or more among a voice and image communication call function, an information output and input function, and a data storage function. In addition, in response to an increasing demand for diversified functions, the terminals have been realized in the form of an all-purpose multimedia player with multiple functions such as photographing a photographic subject as a still image or a moving image, reproducing digital audio and video compression files, playing a game, receiving broadcast signals and so forth.

### SUMMARY OF THE DISCLOSURE

Therefore, an aspect of the detailed description is to provide a mobile terminal that precisely controls an external apparatus (for example, an image display apparatus) based on differences in object-recognizable distance among object detection sensors and a method of controlling the mobile terminal.

To achieve these and other advantages and in accordance with the purpose of this specification, as embodied and broadly described herein, there is provided a mobile terminal including: a display unit to which a touch input is applied to produce a first control command to control the mobile terminal; a proximity sensor; a gesture sensor; a proximity touch sensor; and a controller that produces a second control command different from the first control command when the proximity sensor, the gesture sensor, and the proximity touch sensor sense an object in front of the display unit in this sequence and then the gesture sensor senses a predetermined first gesture, in which the proximity sensor, the gesture sensor, and the proximity touch sensor are different in object-recognizable distance.

In the terminal, first content and second content may be displayed on first and second layers of the display unit, respectively, and based on the control command, the controller may control the display unit in such a manner that the second layer is activated.

In the terminal, when the predetermined first gesture is sensed, the second layer may be inactivated by controlling transparency of the second content.

In the terminal, according to claim 3, when the proximity sensor senses the object and then the gesture sensor senses the predetermined first gesture, the controller may set transparency of the second content to the maximum and thus inactivates the second layer.

In the terminal, when the second layer is inactivated and then a drag operation is sensed, the controller may control the first content that is displayed on the first layer.

In the terminal, when the proximity sensor, the gesture sensor, and the proximity touch sensor do not sense the object in this sequence, and then the gesture sensor senses the predetermined first gesture, the controller may set the transparency of the second content to the maximum and thus inactivates the second layer.

In the terminal, when a third content is displayed on a third layer of the display unit, the gesture sensor, and the proximity touch sensor do not sense the object in this sequence, and then the gesture sensor senses the predetermined first gesture, the controller may set the transparency of the second content and transparency of the third content to the maximum and thus inactivate the second and third layers at the same time.

In the terminal, when the proximity sensor, the gesture sensor, and the proximity touch sensor sense the object in this sequence, and then the gesture sensor senses the predetermined first gesture, the controller may control the second content.

The terminal may further a communication unit that establishes a network between the mobile terminal and an image display apparatus, in which based on the second control command, the controller may generate a first control signal for controlling the image display apparatus, and may transmit the generated first control signal to the image display apparatus over the communication network.

In the terminal, when the gesture sensor, the proximity sensor, and the proximity touch sensor sense the object and then the gesture sensor senses the predetermined first gesture, the controller may generate the first control signal for controlling the image display apparatus.

In the terminal, when the proximity sensor, the gesture sensor, and the proximity touch sensor do not sense the object in this sequence and then the gesture sensor senses the predetermined first gesture, the controller may generate a second control signal for controlling the image display apparatus, and transmits the generated second signal to the image display apparatus over the communication network, and in which the first and second control signals may be different from each other.

The terminal may further include a display unit on which content different from content that is displayed on the image display apparatus is displayed, in which when in a state where the different content is displayed on the display unit, the proximity sensor, the gesture sensor, and the proximity touch sensor sense the object in this sequence and then the gesture sensor senses a predetermined second gesture, the controller may control the content on the image display apparatus.

In the terminal, when the proximity sensor, the gesture sensor, and the proximity touch sensor sense the object in this sequence and then the gesture sensor senses the predetermined second gesture, the controller may capture content that is displayed on the image display apparatus, and displays the captioned content on the display unit.

In the terminal, the captured content may include a caption for the content that is displayed on the image display apparatus, a voice file corresponding to the caption, and an image corresponding to the caption.

In the terminal, when the caption selected on the display unit is selected, the controller may run an application program associated with the caption.

In the terminal, the controller may display on the display unit an icon for outputting the voice file corresponding to the caption or the image corresponding to the caption, along with the caption for the content that is displayed on the image display apparatus.

In the terminal, when a call signal is received, the controller may display the content that is displayed on the display unit or temporarily stops reproducing the content that is displayed on the image display apparatus.

In the terminal, a maximum object-recognizable distance for the gesture sensor may be greater than those for the proximity sensor and the proximity touch sensor, and the maximum object-recognizable distance for the proximity sensor may be greater than that for the proximity touch sensor but smaller than that for the gesture sensor.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a block diagram illustrating a mobile terminal, described in the present specification, according to one embodiment;

FIG. 2A and FIG. 2B are diagrams, each illustrating a telecommunication system in which the mobile terminal according to the present invention can operates;

FIG. 3 is a flow chart illustrating a method of controlling a mobile terminal according to an embodiment of the present invention.

FIG. 4 is a diagram illustrating a home screen (home image) displayed on a first layer of a display unit according to the embodiment of the present invention;

FIG. 5 is a diagram illustrating different application programs that are displayed on different layers of the display unit, respectively, according to the embodiment of the present invention;

FIG. 6 is a diagram illustrating maximum object-recognizable distances for object detection sensors according to the embodiment of the present invention;

FIG. 7 is a diagram illustrating a process of controlling transparency of content according to the embodiment of the present invention;

FIG. 8 is a diagram illustrating a method of changing the home screen (home image) according to the embodiment of the present invention;

FIG. 9 is a flow chart illustrating a method of controlling the mobile terminal according to another embodiment of the present invention;

FIGS. 10A and 10B are diagrams illustrating a process of controlling the content according to another embodiment of the present invention;

FIG. 11 is a diagram illustrating a gesture table for controlling content on an image display apparatus according to another embodiment of the present invention;

FIG. 12 is a flowchart illustrating a method of controlling the mobile terminal according to another embodiment of the present invention;

FIG. 13 is a diagram illustrating the mobile terminal that is connected to the image display apparatus over a wireless communication network according to one embodiment of the present invention;

FIG. 14 is a diagram illustrating a process of controlling the image display apparatus according to one embodiment of the present invention;

FIG. 15 is a flow chart illustrating a method of controlling the mobile terminal according to another embodiment of the present invention;

FIGS. 16A and 16B are diagrams illustrating a process of controlling the content on the image display apparatus according to another embodiment of the present invention;

FIG. 17 is a flow chart illustrating a method of controlling the mobile terminal according to another embodiment of the present invention;

FIG. 18 is a diagram illustrating a process for capturing the content on the image display apparatus according to another embodiment of the present invention;

FIG. 19 is a diagram illustrating the captured content according to another embodiment of the present invention; and

FIG. 20 is a diagram illustrating a process of running a program associated with the captured content according to another embodiment of the present invention.

### DETAILED DESCRIPTION OF THE DISCLOSURE

Hereinafter, the present disclosure will be explained in more detail with reference to the attached drawings. For the sake of brief description with reference to the drawings, the same or equivalent components will be provided with the same reference numbers, and description thereof will not be repeated. The suffixes “module” and “unit or portion” for components used in the following description merely provided only for facilitation of preparing this specification, and thus they are not granted a specific meaning or function. If it is regarded that detailed descriptions of the related art are not within the range of the present invention, the detailed descriptions will be omitted. Furthermore, it should also be understood that embodiments are not limited by any of the details of the foregoing description, but rather should be construed broadly within its spirit and scope and it is intended that the present invention cover modifications and variations of this invention provided they come within the scope of the appended claims and their equivalents.

A terminal in the present description may include a mobile terminal such as a portable phone, a smart phone, a notebook computer, a digital broadcasting terminal, Personal Digital Assistants (PDA), Portable Multimedia Player (PMP), a navigation system, a slate PC, a tablet PC and an ultra book. However, it will be obvious to those skilled in the art that the present invention may be also applicable to a fixed terminal such as a digital TV and a desktop computer, except for specific configurations for mobility.

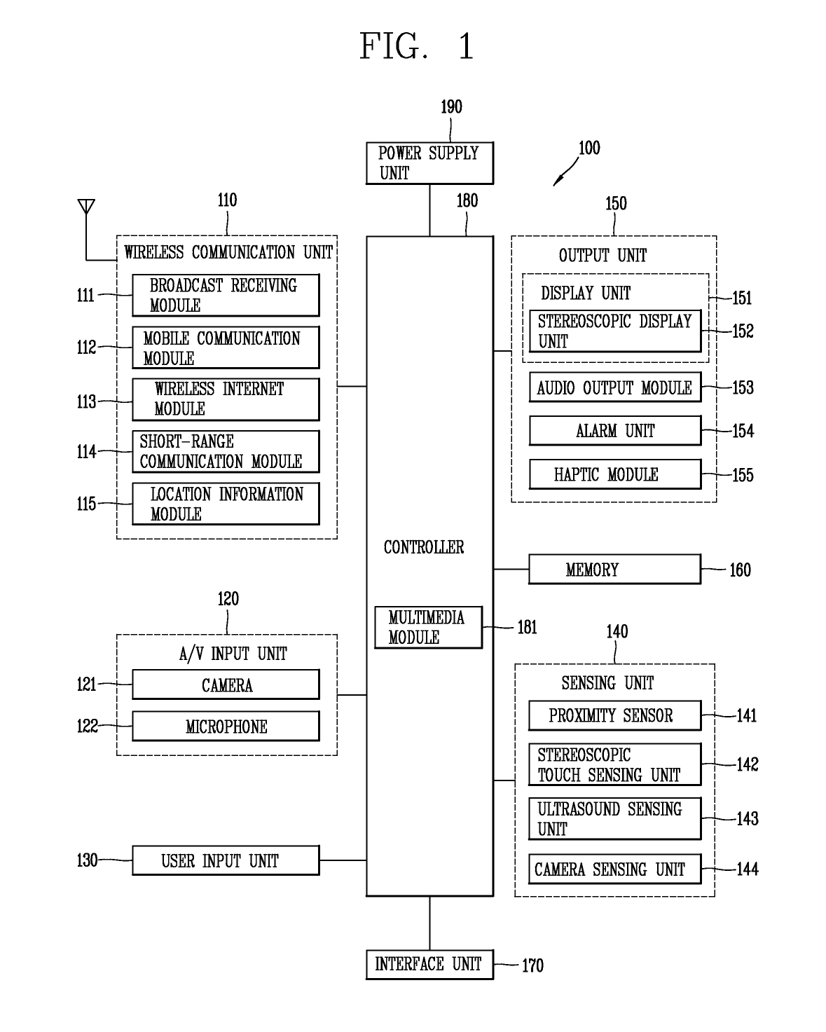

FIG. 1 is a diagram illustrating a mobile terminal according to one embodiment of the present invention.

The mobile terminal 100 may comprise components, such as a wireless communication unit 110, an Audio/Video (NV) input unit 120, a user input unit 130, a sensing unit 140, an output unit 150, a memory 160, an interface unit 170, a controller 180, a power supply 190 and the like. FIG. 1 shows the mobile terminal 100 having various components, but it is understood that implementing all of the illustrated components is not a requirement. Greater or fewer components may alternatively be implemented.

Hereinafter, each component 110 to 190 is described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module or a wireless fidelity (WiFi) module.

Still referring to FIG. 1, the A/V input unit 120 is configured to provide audio or video signal input to the mobile terminal. The NV input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 153, an alarm unit 154 and a haptic module 155.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

The display unit 151 may also be implemented as a stereoscopic display unit 152 for displaying stereoscopic images.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, a switchable scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

As illustrated, a left image and a right image required for implementing a 3D stereoscopic image is displayed on the stereoscopic display unit 152 by a stereoscopic processing unit (not shown). The stereoscopic processing unit may receive the 3D image and extract the left image and the right image, or may receive the 2D image and change it into a left image and a right image.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the mobile terminal 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. A maximum distance for sensing an object by the proximity sensor 141 may be 4-5 cm.

Hereinafter, for the sake of brief explanation, a status that the pointer is positioned to be proximate onto the touch screen without contact will be referred to as ‘floating touch’ or ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor. That is, the touch screen (touch sensor) may include a contact touch sensor for sensing a contact touch, and a proximity touch sensor for sensing a proximity touch (or a non-contact touch). A maximum distance for sensing an object by the proximity touch sensor may be 1-2 cm.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus pen) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light and the ultrasonic sensors may be configured to sense ultrasonic waves. Since light is much faster than ultrasonic waves, a time for which the light reaches the optical sensor is much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 includes at least one of a camera 121, a photo sensor, and a laser sensor.

For example, the camera 121 and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The sensing unit 140 may further include a gesture sensor 145. The gesture sensor 145 for sensing a gesture is configured to sense various gestures such as a hand shape, a finger shape, and a hand motion. A maximum distance for sensing an object by the gesture sensor 145 may be 15˜30 cm.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer or the like.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, using vibration to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system which is operable with the mobile terminal 100 according to the present disclosure will be described.

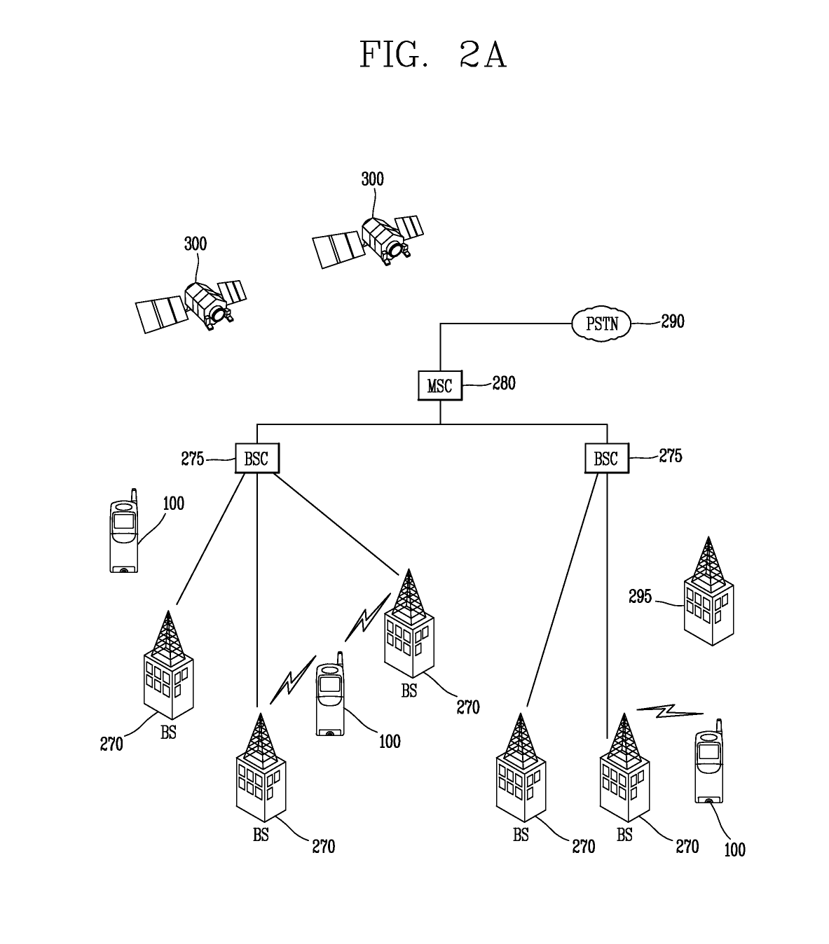

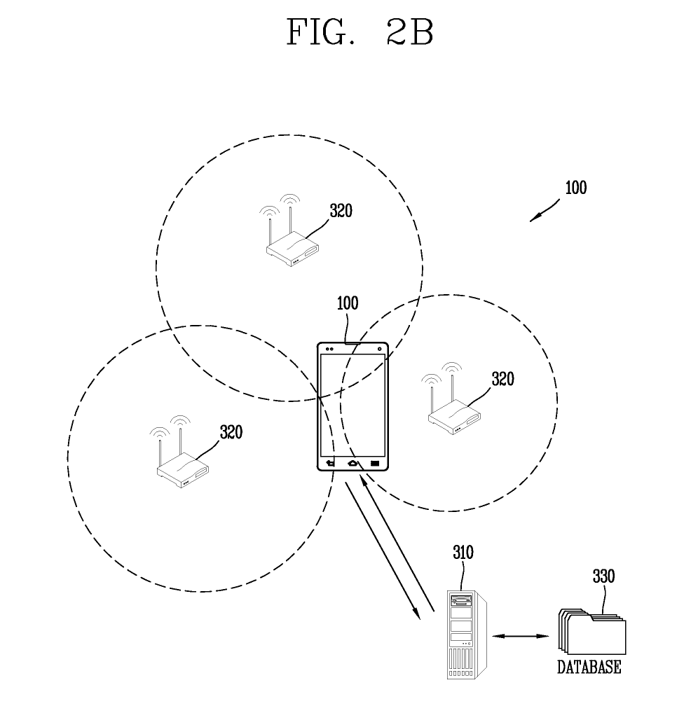

FIGS. 2A and 2B are conceptual views of a communication system operable with a mobile terminal 100 in accordance with the present disclosure.

First, referring to FIG. 2A, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

Referring now to FIG. 2A, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2A.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 2A, transmits a broadcast signal to the mobile terminals 100 operating within the system. The broadcast receiving module 111 (FIG. 1) is typically configured inside the mobile terminal 100 to receive broadcast signals transmitted by the BT 295.

FIG. 2A further depicts several Global Positioning System (GPS) satellites 300. Such satellites 300 facilitate locating the position of at least one of plural mobile terminals 100. Two satellites are depicted in FIG. 2A, but it is understood that useful position information may be obtained with greater or fewer satellites than two satellites. The GPS module 115 (FIG. 1) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and executing other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

Hereinafter, description will be given of a method for acquiring location information of a mobile terminal using a wireless fidelity (WiFi) positioning system (WPS), with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Hereinafter, a mobile terminal capable of precisely controlling an external device such as an image display apparatus, based on a difference between object sensing distances by various sensors, and a control method thereof will be explained. The image display apparatus may be a tablet personal computer, a television, a notebook computer, etc.

The mobile terminal of the present invention generates a first control command for controlling the mobile terminal, based on a touch input applied to the display unit 151, and generates a second control command based on a proximity touch applied to a region adjacent to the display unit 151. Based on the first and second control commands, the controller 180 may operate the mobile terminal or control an external device connected to the mobile terminal wirelessly or by wire. Hereinafter, various embodiments will be explained.

Firstly, a mobile terminal capable of controlling content thereof based on a difference between object sensing distances by sensors, and based on a gesture, and a control method thereof will be explained.

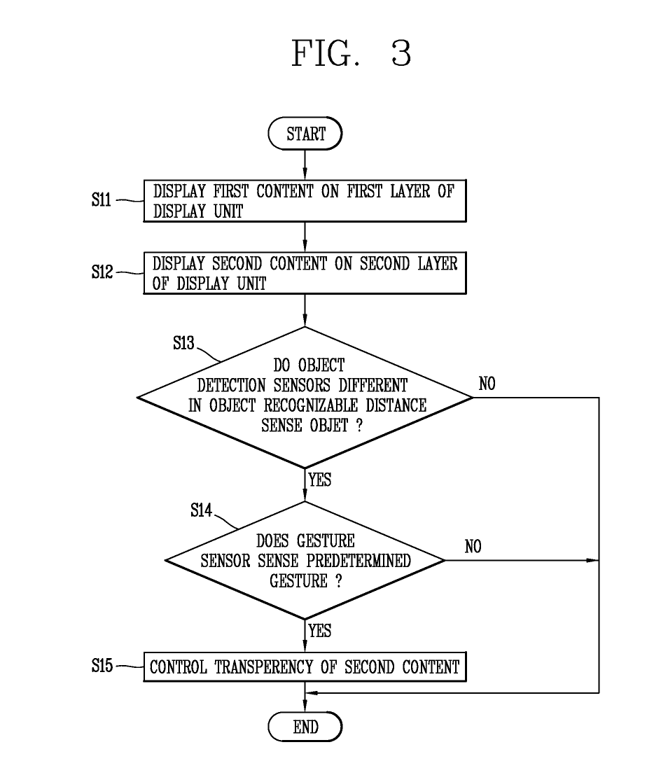

FIG. 3 is a flow chart illustrating a method of controlling a mobile terminal according to an embodiment of the present invention.

First, when the mobile terminal 100 is in a home screen mode, the controller 180 displays a home screen (content) on a first layer of the display unit 151 (S11). The home screens may be two or more in number, and each home screen includes multiple icons that correspond to multiple application programs, respectively. For example, each time a user's drag operation is detected, the controller 180 sequentially displays a first home screen, a second home screen, and so forth up to a n-th home screen on the first layer of the display unit 151 (home screen change). At this point, n is a natural number.

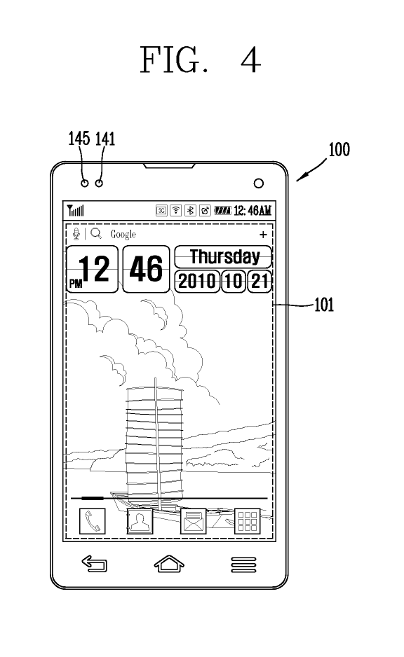

FIG. 4 is a diagram illustrating the home screen (home image) displayed on the first layer of the display unit 151 according to the embodiment of the present invention.

As illustrated in FIG. 4, each time the user's drag operation is detected, the controller 180 sequentially displays the first home screen (content), the second home screen, and so forth up to the n-th home screen on the first layer of the display unit 151.

According to a user's request (for example, a touch input, a gesture input, object recognition, and the like), the controller 180 displays a first application program (content) on a second layer of the display unit 151 (S12). The first application program is one among a moving-image reproduction application program, a photograph application program, an Internet application program, a messenger application program, and a YouTube application program. The first application program is an application program that is adjustable in transparency.

According to the user's request (for example, the touch input, the gesture input, the object recognition, and the like), the controller 180 may display a second application program (content) on a third layer of the display unit 151. For example, the controller 180 displays the first and second application programs together through a multi-tasking function. The second application program is one among the moving-image reproduction application program, the photograph application program, the Internet application program, the messenger application program, and the YouTube application program. That is, while viewing a moving image (first application program) or a message (first application program), the user can view a web page (second application program) or a photograph (second application) and the like at the same time. The second application program is an application program that is adjustable in transparency.

Each of the first and second application programs that are adjustable in transparency is an application program that includes a transparency adjustment bar. The controller 180 displays (sets) the transparency adjustment bar on at least one or more application programs that are selected from among multiple applications programs. At the request of the user, the controller 180 may adjust not only the transparency of, but also a size and a position of each the first and second application programs. Each of the first and second application programs means each of the first and third layers.

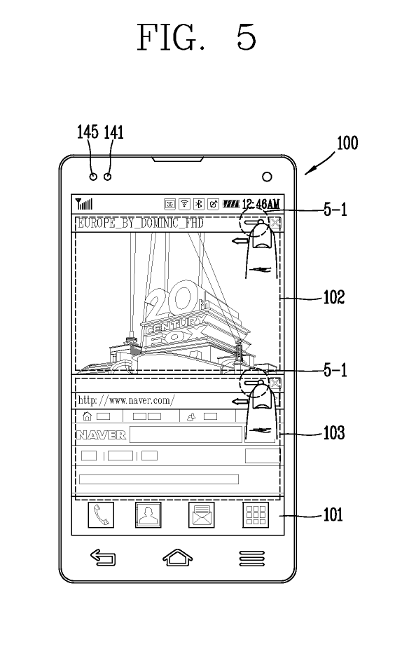

FIG. 5 is a diagram illustrating different application programs that are displayed on different layers of the display unit, respectively, according to the embodiment of the present invention.

As illustrated in FIG. 5, according to user's selection, the controller 180 displays a first application program 102 and a second application program 103, each of which has a transparency adjustment bar (icon) 5-1, on the display unit 151. For example, the controller 180 displays the first application program 102 having the transparency adjustment bar (icon) 5-1 on the second layer of the display unit 151, and displays the second application program 103 having the transparency adjustment bar (icon) 5-1 on the third layer of the display unit 151. According to the user's selection, the controller 180 may display the first and second application programs 102 and 103, each of which has the transparency adjustment bar (icon) 5-1, on different positions in the display unit 151, respectively.

As the user moves the transparency adjustment bar (icon) 5-1 leftward or rightward, the controller 180 adjusts the transparency of the corresponding application program 102 or 103. For example, as the transparency adjustment bar (icon) 5-1 is moved, the controller 180 adjusts the transparency of the moving-image reproduction application program 102 or of the Internet application program 103. The user checks pieces of information (for example, an image, a moving image, a memo, an Internet site (web page), a message, and the like) provided through the first and second application programs 102 and 103 by adjusting the transparency of the first application program and the transparency of the second application program differently through their respective transparency adjustment bars (icons) 5-1.

The user changes a home screen (home image) 101 displayed on the first layer of the display unit 151 to another home screen, based on the drag operation, after inactivating the second layer and the third layer. The second layer is inactivated by adjusting the transparency adjustment bar (icon) 5-1 of the first application program 102 displayed on the second layer of the display unit 151 and thus setting the transparency of the first application program 102 to the maximum (the highest transparency). The third layer is inactivated by adjusting the transparency adjustment bar (icon) 5-1 of the second application programs 103 displayed on the third layer of the display unit 151 and thus setting the transparency of the second application program to the maximum (the highest transparency). This causes great inconvenience to the user in that the user has to perform multiple operations to change the home screen (home image) 101 displayed on the first layer of the display unit 151 to another home screen. Therefore, a method is described below in which the home screen 101 displayed on the first layer of the display unit 151 is changed to another home screen in an easy, fast manner by setting the transparency of the first application program 102 displayed on the second layer of the display unit 151 and the transparency of the second application program 103 together, in an easy, fast manner, to the maximum and thus inactivating the second and third layers at the same time.

The controller 180 determines whether object detection sensors (for example, a proximity sensor 141, the gesture sensor 145, a proximity touch sensor, and the like) sense an object (S13). For example, the controller 180 determines whether the gesture sensor 145, the proximity sensor 141, and the proximity touch sensor sense the object in this sequence. In other words, the controller 180 determines whether the gesture sensor 145 sense the object, then the controller 180 determines whether the proximity sensor 141 sense the object, then the controller 180 determines whether the proximity touch sensor sense the object. At this point, the gesture sensor 145, the proximity sensor 141, and the proximity touch sensor are different in a maximum object-sensible distance. The gesture sensor 145 is 15 to 30 cm, the proximity sensor is 4 to 5 cm, and the proximity touch sensor is 1 to 2 cm in the maximum object-sensible (-recognizable) distance. The proximity sensor 141 and the gesture sensor 145 that are the object detection sensor are arranged adjacent to each other, and the proximity sensor 141 and the gesture sensor 145 are arranged adjacent to the proximity touch sensor included in the touch screen.

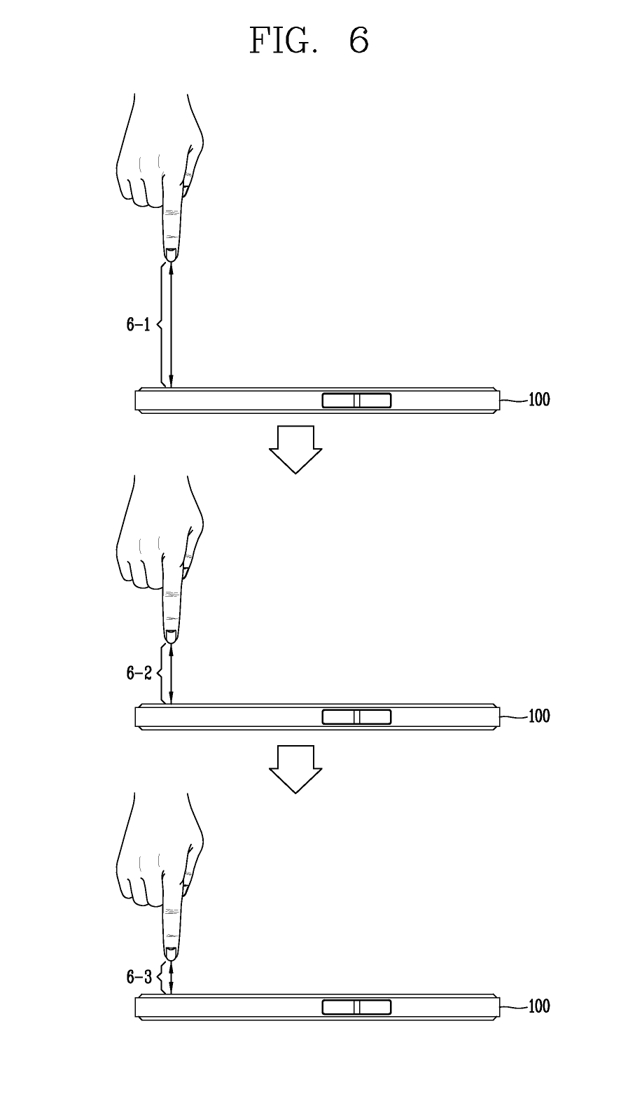

FIG. 6 is a diagram illustrating the maximum object-recognizable distances for the object detection sensors according to the embodiment of the present invention.

As illustrated in FIG. 5, the gesture sensor 145, the proximity sensor 141, and the proximity touch sensor are different in the maximum object-sensible distance. A maximum object-sensible (recognizable) distance 6-1 of the gesture sensor 145 is 15 to 30 cm. A maximum object-sensible (recognizable) distance 6-2 of the proximity sensor 141 is 4 to 5 cm. A maximum object-sensible (recognizable) distance 6-3 of the proximity touch sensor is 1 to 2 cm. Therefore, the controller 180 determines whether the gesture sensor 145, the proximity sensor 141, and the proximity touch sensor detects the object in this sequence or whether or the proximity touch sensor, the proximity sensor 141, and the gesture sensor 145 detects the object in this sequence. At this point, when the object is positioned at an object-detectable distance for the proximity touch sensor, the gesture sensor 145 and the proximity sensor 141, as well as the proximity touch sensor, operate. However, when the object is positioned at an object-detectable distance for the gesture sensor 145, the gesture sensor 145 operates, but the proximity touch sensor and the proximity sensor 141 do not operate.

The controller 180 determines whether the object detection sensors (for example, the proximity sensor 141, the gesture sensor 145, the proximity touch sensor, and the like) sense a predetermined gesture (for example, a shape of a human hand, a palm of the human hand, and the like) (S14). For example, the controller 180 determines (detects) whether the gesture sensor 145, the proximity sensor 141, and the proximity touch sensor sense an object in this sequence and then the gesture sensor 145 senses a predetermined gesture (for example, a gesture for controlling the transparency). Alternatively, the controller 180 determines (detects) whether the gesture sensor 145 and the proximity sensor 141 senses the object (without the proximity touch sensor sensing the object) in this sequence, and then the gesture sensor 145 senses the predetermined gesture (for example, the gesture for controlling the transparency.

When the gesture sensor 145 among the object detection sensors (for example, the proximity sensor 141, the gesture sensor 145, the proximity touch sensor and the like sense) senses a predetermined gesture (for example, the gesture for controlling the transparency), the controller 180 controls the transparency of the first application program 102 displayed on the second layer of the display unit 151 and the transparency of the second application program 103 (S15).

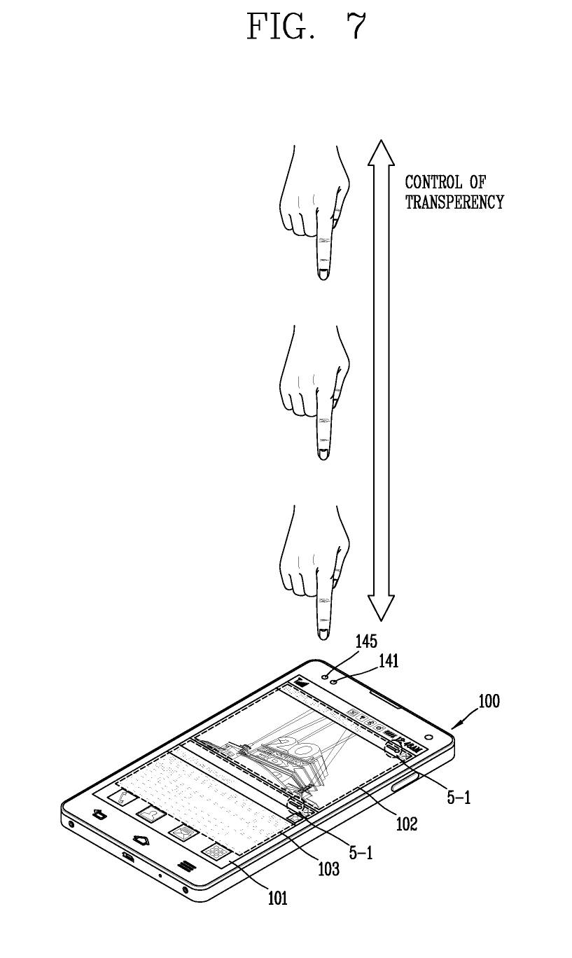

FIG. 7 is a diagram illustrating a process of controlling the transparency of content according to the embodiment of the present invention.

As illustrated in FIG. 7, when the gesture sensor 145, the proximity sensor 141, and the proximity touch sensor sense an object in this sequence and then the gesture sensor 145 senses a predetermined gesture (for example, the gesture for controlling the transparency), the controller inactivates the second and third layers at the same time by setting the transparency of the first application program 102 and the transparency of the second application program 103 together to the maximum.

When the gesture sensor 145, the proximity sensor 141, and the proximity touch sensor sense an object in this sequence, and then the gesture sensor 145 senses a predetermined gesture (for example, a gesture for inactivating layers that are adjustable in transparency), regardless of the transparency of the first application program and the transparency of the second application program, the controller 180 may inactivate the second and third layers at the same time.

When regardless of whether the gesture sensor 145, the proximity sensor 141, and proximity touch sensor sense the object, the gesture sensor 145 senses a predetermined gesture (for example, the gesture for inactivating the layers that are adjustable in transparency), regardless of the transparency of the first application program 102 and the transparency of the second application program 103, the controller 180 may the second and third layers at the same time.

When the gesture sensor 145 and the proximity sensor 141 sense an object in this sequence (without the proximity touch sensor sensing the object), and then the gesture sensor 145 senses a predetermined gesture (for example, the gesture for controlling the transparency), the controller 180 may inactivate the second and third layers at the same time by setting the transparency of the first application program 102 and the transparency of the second application program together to the maximum. In contrast, when the proximity touch sensor and the proximity sensor 141 do not sense an object in this sequence (the object is in a non-sensed state), and then the gesture sensor 145 senses a predetermined gesture (for example, the gesture for controlling the transparency), the controller 180 may inactivate the second and third layers at the same time by setting the transparency of the first application program 102 and the transparency of the second application program 103. The first and third layers are inactivated and then according to the user's touch input, the home screen displayed on the first layer is controlled.

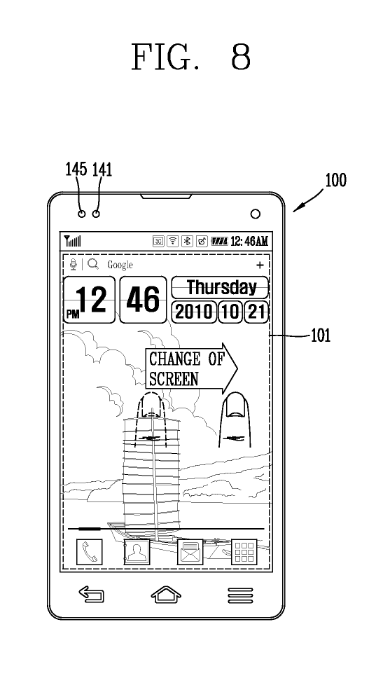

FIG. 8 is a diagram illustrating a method of changing the home screen (home image) according to the embodiment of the present invention.

As illustrated in FIG. 8, when the gesture sensor 145 among the object detections sensors (for example, the proximity sensor 141, the gesture sensor 145, the proximity touch sensor and the like) senses a predetermined gesture (for example, the gesture for controlling the transparency), the controller 180 sets the transparency of the first application program 102 displayed on the second layer of the display unit 151 and the transparency of the second application program 103 to the maximum (the first and second application programs are made transparent) and, when the drag operation by the user is sensed, changes the home screen 101 displayed on the first layer.

Accordingly, in the mobile terminal and the method of controlling the mobile terminal according to the embodiment of the present invention and the method, the transparency of specific content that is displayed on the mobile terminal is controlled based on the difference in the object-recognizable distance among the object detection sensors and on the gesture. Thus, content is displayed on a low-level layer below the specific content is controlled in a fast, convenient manner.

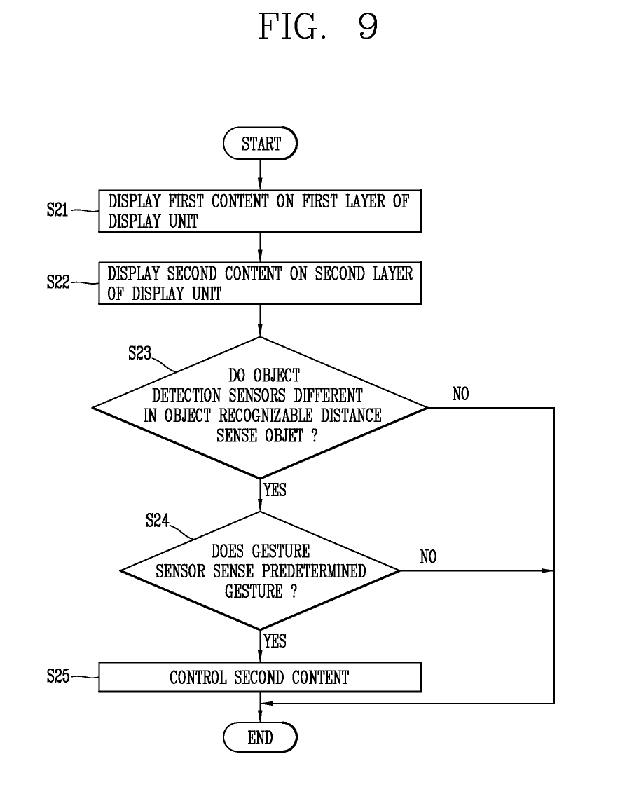

FIG. 9 is a flowchart illustrating a method of controlling the mobile terminal according to another embodiment of the present invention.

First, when the mobile terminal 100 is in a home screen mode, the controller 180 displays the home screen (content) on the first layer of the display unit 151 (S21). The home screens may be two or more in number, and each home screen includes multiple icons that correspond to multiple application programs, respectively. For example, each time a user's drag operation is detected, the controller 180 sequentially displays a first home screen, a second home screen, and so forth up to a n-th home screen on the first layer of the display unit 151 (home screen change). At this point, n is a natural number.

The controller 180 displays the first application program (content) on the second layer of the display unit 151 at the request of the user (for example, the touch input, the gesture input, the object recognition, and the like) (S22). The first application program is one among a moving-image reproduction application program, a photograph application program, an Internet application program, a messenger application program, and a YouTube application program. The first application program is an application program that is adjustable in transparency. The controller 180 may display the second application program (content) on the third layer of the display unit 151 at the request of the user (for example, the touch input, the gesture input, the object recognition, and the like). For example, the controller 180 displays the first and second application programs together on the display unit 151 through the multi-tasking function. The second application program is one among the moving-image reproduction application program, the photograph application program, the Internet application program, the messenger application program, and the YouTube application program. That is, while viewing a moving image (first application program) or a message (first application program), the user can view a web page (second application program) or a photograph (second application) and the like at the same time. The second application program is an application program that is adjustable in transparency.

The controller 180 determines whether the object detection sensors (for example, the proximity sensor 141, the gesture sensor 145, the proximity touch sensor, and the like) sense an object (S23). For example, the controller 180 determines whether the gesture sensor 145, the proximity sensor 141, and the proximity touch sensor sense the object in this sequence. At this point, the gesture sensor 145, the proximity sensor 141, and the proximity touch sensor are different in a maximum object-sensible distance. The gesture sensor 145 is 15 to 30 cm, the proximity sensor 141 is 4 to 5 cm, and the proximity touch sensor is 1 to 2 cm in the maximum object-sensible (-recognizable) distance. The proximity sensor 141 and the gesture sensor 145 that are the object detection sensor are arranged adjacent to each other, and the proximity sensor 141 and the gesture sensor 145 are arranged adjacent to the proximity touch sensor included in the touch screen.

The controller 180 determines whether the gesture sensor 145 among the object detection sensors (for example, the proximity sensor 141, the gesture sensor 145, the proximity touch sensor, and the like) senses a predetermined gesture (for example, the shape of the human hand, the palm of the human hand, and the like) (S24). For example, the controller 180 determines (detects) whether the gesture sensor 145, the proximity sensor 141, and the proximity touch sensor senses an object in this sequence and then the gesture sensor 145 senses a predetermined gesture (for example, a gesture for controlling content). Alternatively, the controller 180 determines (detects) whether the gesture sensor 145 and the proximity sensor 141 sense the object in this sequence (without the proximity touch sensor sensing the object) and then the gesture sensor 145 senses a predetermined gesture (for example, a gesture for controlling the transparency).

When the gesture sensor 145 among the object detection sensors (for example, the proximity sensor 141, the gesture sensor 145, the proximity touch sensor, and the like) senses a predetermined gesture (for example, the gesture for controlling the transparency), the controller 180 controls the first application program (content) 102 displayed on the second layer of the display unit 151 (S25).

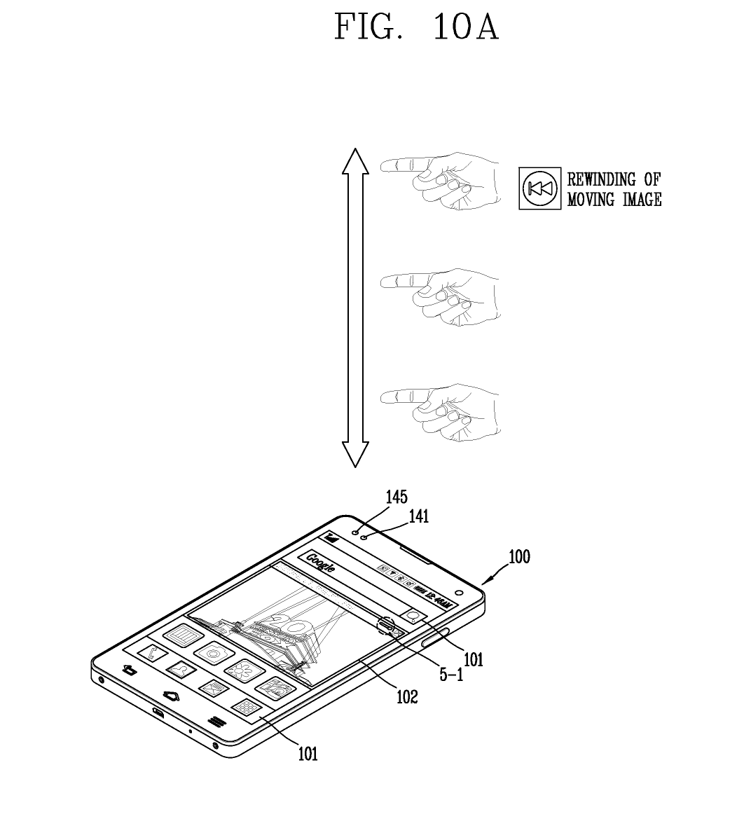

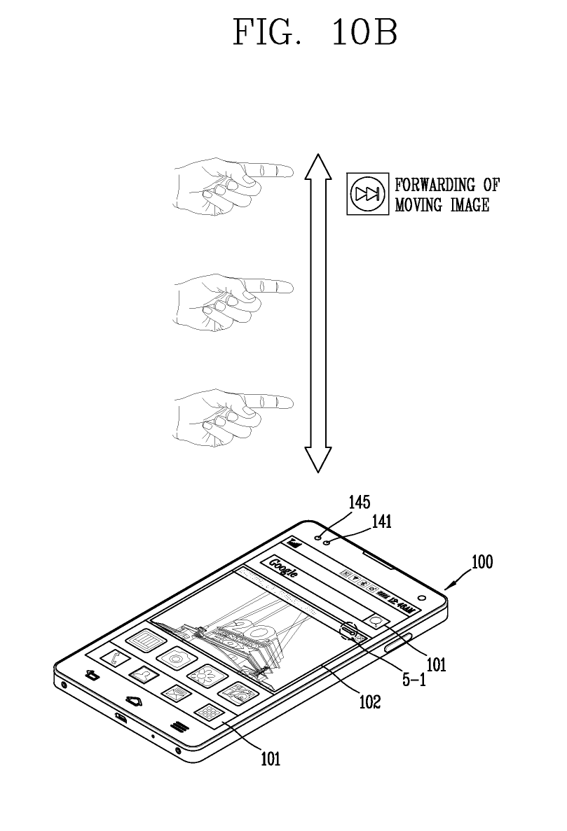

FIGS. 10A and 10B are diagrams illustrating a process of controlling the content according to another embodiment of the present invention.

As illustrated in FIG. 10A, when the gesture sensor 145, the proximity sensor 141, and the proximity touch sensor sense an object in this sequence and then the gesture sensor 145 senses a predetermined gesture (for example a gesture for rewinding the moving image), the controller 180 performs an operation for rewinding the moving image 102 displayed on the second layer of the display unit 151. When regardless of whether the gesture sensor 145, the proximity sensor 141, and the proximity touch sensor senses the object, the gesture sensor 145 senses a predetermined gesture (for example, the gesture for rewinding the moving image), the controller 180 performs the operation for rewinding the moving image 102 displayed on the second layer of the display unit 151.

When the gesture sensor 145 continues to sense a predetermined gesture (for example, the gesture for rewinding the moving image) with the passage of time, the controller 180 continues to perform the operation for rewinding the moving image 102 displayed on the second layer of the display unit 151. In contrast, when the gesture sensor 145 no longer senses the predetermined gesture (for example, the gesture for rewinding the moving image), the controller 180 stops the operation for rewinding the moving image 102 displayed on the second layer of the display unit 151.

When the gesture sensor 145 and the proximity sensor 141 sense an object in this sequence (without the proximity touch sensor sensing the object), and then the gesture sensor 145 senses a predetermined gesture (for example, the gesture for rewinding the moving image), the controller 180 may perform the operation for rewinding the moving image 102 displayed on the second layer of the display unit 151. In contrast, when the proximity touch sensor and the proximity sensor 141 do not sense an object in this sequence (the object is in the non-sensed state), and then the gesture sensor 145 senses a predetermined gesture (for example, the gesture for rewinding the moving image), the controller 180 may perform the operation for rewinding the moving image 102 displayed on the second layer of the display unit 151.

When the proximity touch sensor and the proximity sensor 141 do not sense the object in this sequence (the object is in the non-sensed state) and then the gesture sensor 145 continues to sense a predetermined gesture (for example, the gesture for rewinding the moving image) with the passage of time, the controller 180 continues to perform the operation for rewinding the moving image 102 displayed on the second layer of the display unit 151.

As illustrated in FIG. 10B, when the gesture sensor 145, the proximity sensor 141, and the proximity touch sensor sense an object in this sequence and then the gesture sensor 145 senses a predetermined gesture (for example a gesture for forwarding a moving image), the controller 180 performs the operation for forwarding the moving image 102 displayed on the second layer of the display unit 151. When regardless of whether the gesture sensor 145, the proximity sensor 141, and the proximity touch sensor senses the object, the gesture sensor 145 senses a predetermined gesture (for example, the gesture for forwarding the moving image), the controller 180 performs the operation for forwarding the moving image 102 displayed on the second layer of the display unit 151.

When the gesture sensor 145 continues to sense a predetermined gesture (for example, the gesture for forwarding the moving image) with the passage of time, the controller 180 continues to perform the operation for forwarding the moving image 102 displayed on the second layer of the display unit 151. On the other hand, When the gesture sensor 145 no longer senses the predetermined gesture (for example, the gesture for forwarding the moving image), the controller 180 stops the operation for forwarding the moving image 102 displayed on the second layer of the display unit 151.

When the gesture sensor 145 and the proximity sensor 141 sense an object in this sequence (without the proximity touch sensor sensing the object), and then the gesture sensor 145 senses a predetermined gesture (for example, the gesture for forwarding the moving image), the controller 180 may perform the operation for forwarding the moving image 102 displayed on the second layer of the display unit 151. On the other hand, when the proximity touch sensor and the proximity sensor 141 do not sense an object in this sequence (the object is in the non-sensed state) and then the gesture sensor 145 senses a predetermined gesture (for example, the gesture for forwarding the moving image), the controller 180 may perform the operation for forwarding the moving image 102 displayed on the second layer of the display unit 151.

When the proximity touch sensor and the proximity sensor 141 do not sense an object in this sequence (the object is in the non-sensed state) and then the gesture sensor 145 senses a predetermined gesture (for example, the gesture for forwarding the moving image) with the passage of time, the controller 180 continue to perform the operation for forwarding the moving image 102 displayed on the second layer of the display unit 151.

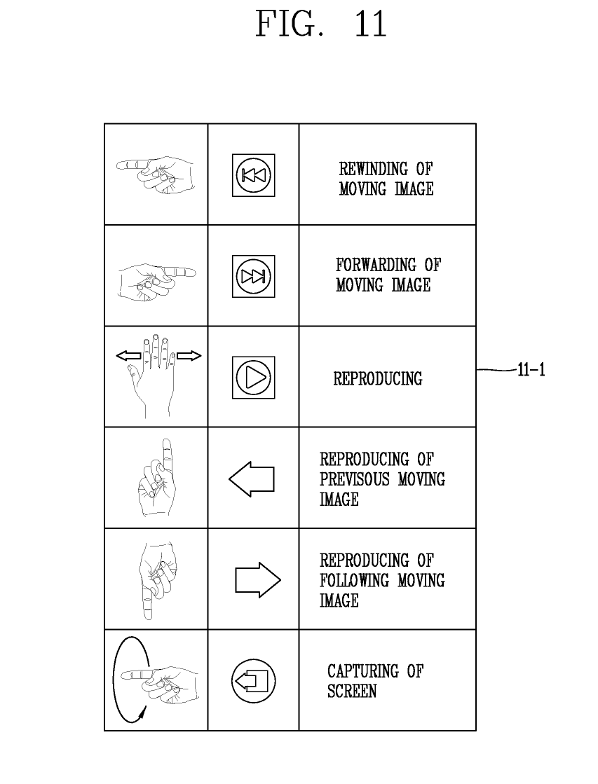

FIG. 11 is a diagram illustrating a gesture table for controlling content on an image display apparatus according to another embodiment of the present invention.

As illustrated in FIG. 11, when the user makes a request for a gesture table 11-1 for controlling content on an image display apparatus 200, the controller 180 displays the gesture table 11-1 on the display unit 151. Therefore, the user can control the content that is displayed on the display unit in an easy, fast manner by checking the gesture table 11-1. In addition to the gestures in the displayed gesture table 11-1, the gesture table 11-1 may further include various gestures for controlling the content.

Therefore, in the mobile terminal and the method of controlling the mobile terminal according to the embodiment of present invention, content is controlled in a fast, convenient manner, based on the differences in the object-recognizable distance among the object detection sensors and on the gesture sensed through the gesture sensor.

As described in detail above, in the mobile terminal and the method of controlling the mobile terminal according to the embodiments of the present invention, the content is controlled in a fast, convenient manner, based on the differences in the object-recognizable distance among the object detection sensors and on the gesture sensed through the gesture sensor.

In the mobile terminal and in the method of controlling the mobile terminal according to the embodiments of the present invention, the transparency of specific content that is displayed on the mobile terminal is controlled based on differences in the object-recognizable distance among the object detection sensors and on the gesture. Thus, content is displayed on a low-level layer below the specific content is controlled in a fast, convenient manner.

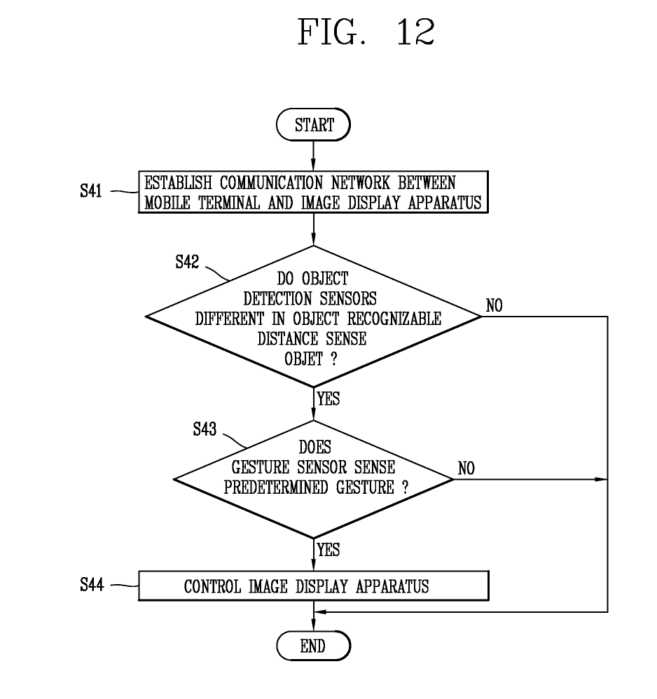

FIG. 12 is a flowchart illustrating a method of controlling the mobile terminal according to another embodiment of the present invention.

First, the controller 180 establishes a communication network between the mobile terminal and the image display apparatus through the wireless communication unit 110 (for example, a short-range communication module 114) (S11). The controller 180 establishes the communication network between the mobile terminal and the image display apparatus through the wireless communication unit 110 (for example, the short-range communication module 114) and displays content (for example, a web page, a moving image, a music file, a photo file, and the like) requested by the user on the display unit 151. The controller 180 displays content that is displayed on the display unit 151, on the image display apparatus, based on a predetermined gesture sensed by the gesture sensor 145, or displays the content that is displayed on the image display apparatus, on the display unit 151, based on the predetermined gesture sensed by the gesture sensor 145.

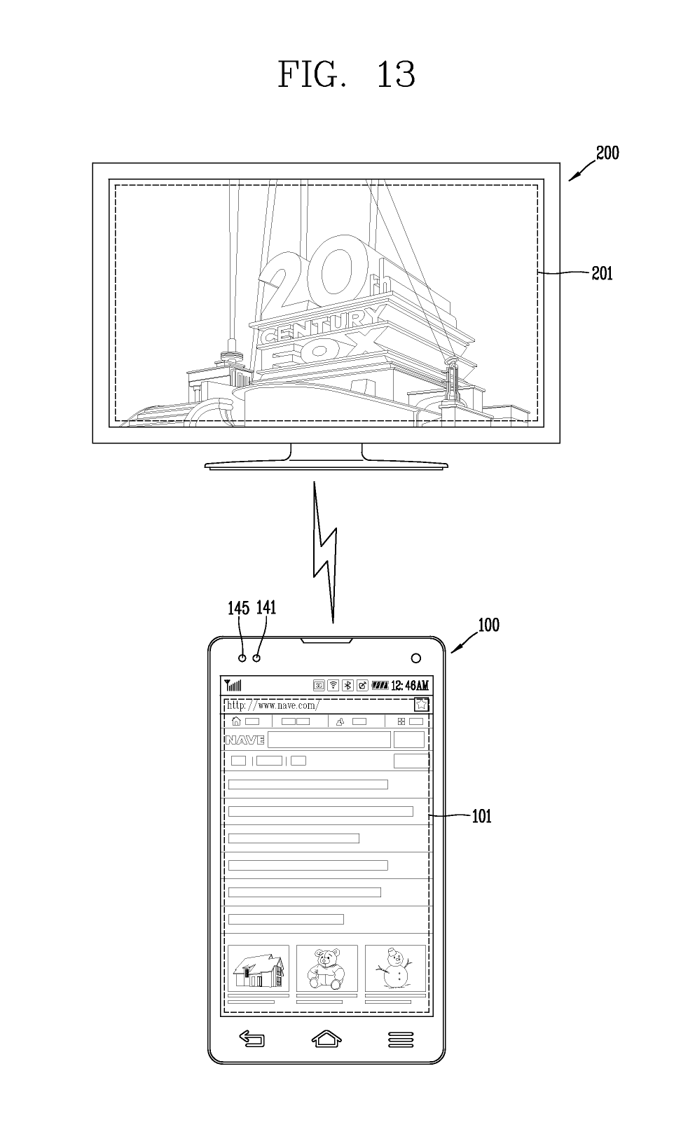

FIG. 13 is a diagram illustrating the mobile terminal that is connected to the image display apparatus over a wireless communication network according to another embodiment.

As illustrated in FIG. 13, the controller 180 establishes a wire or wireless communication network between the mobile terminal 100 and the image display apparatus 200, and displays content (for example, the web page, the moving image, the music file, the photo file, and the like) 101 requested by the user on the display unit 151. The image display apparatus 200 displays different content (for example, a moving image) 201 from the content (for example, the web page) display on the display unit 151, and may display the same content as that displayed on the display unit 151.

The controller 180 displays content that is displayed on the display unit 151, on the image display apparatus, based on a predetermined gesture sensed by the gesture sensor 145, or displays content that is displayed on the image display apparatus on the display unit 151, based on a predetermined gesture sensed by the gesture sensor 145.

When a call signal is received, the controller 180 displays content (for example, the web page) displayed on the display unit 151 on the image display apparatus. Alternatively, when the call signal is received, the controller 180 generates a control signal for temporarily stopping reproducing content (for example, the moving image) that is displayed on the image display apparatus) and may transmit the control signal to the image display apparatus. When the call signal is received, the image display apparatus temporarily stops reproducing the content that is displayed on the image display apparatus, based on the control signal received from the controller 180.

The proximity sensor 141 and the gesture sensor 145 that are the object detection sensor are arranged adjacent to each other, and the proximity sensor 141 and the gesture sensor 145 are arranged adjacent to the proximity touch sensor included in the touch screen.

The controller 180 determines whether the object detection sensors (for example, a proximity sensor 141, the gesture sensor 145, a proximity touch sensor, and the like) senses an object (S12). For example, the controller 180 determines whether the gesture sensor 145, the proximity sensor 141, and the proximity touch sensor sense the object in this sequence. At this point, the gesture sensor 145, the proximity sensor 141, and the proximity touch sensor are different in the maximum object-sensible distance. The gesture sensor 145 is 15 to 30 cm, the proximity sensor 141 is 4 to 5 cm, and the proximity touch sensor is 1 to 2 cm in the maximum object-sensible (-recognizable) distance.

When the gesture sensor 145 among the object detection sensors (for example, the proximity sensor 141, the gesture sensor 145, the proximity touch sensor, and the like) senses a predetermined gesture (for example, a human finger, and the palm of the human hand, and the like), the controller 180 generates a control signal for controlling the image display apparatus 200, transmits the generated control signal to the image display apparatus 200, and thus controls the image display apparatus 200 (S14).

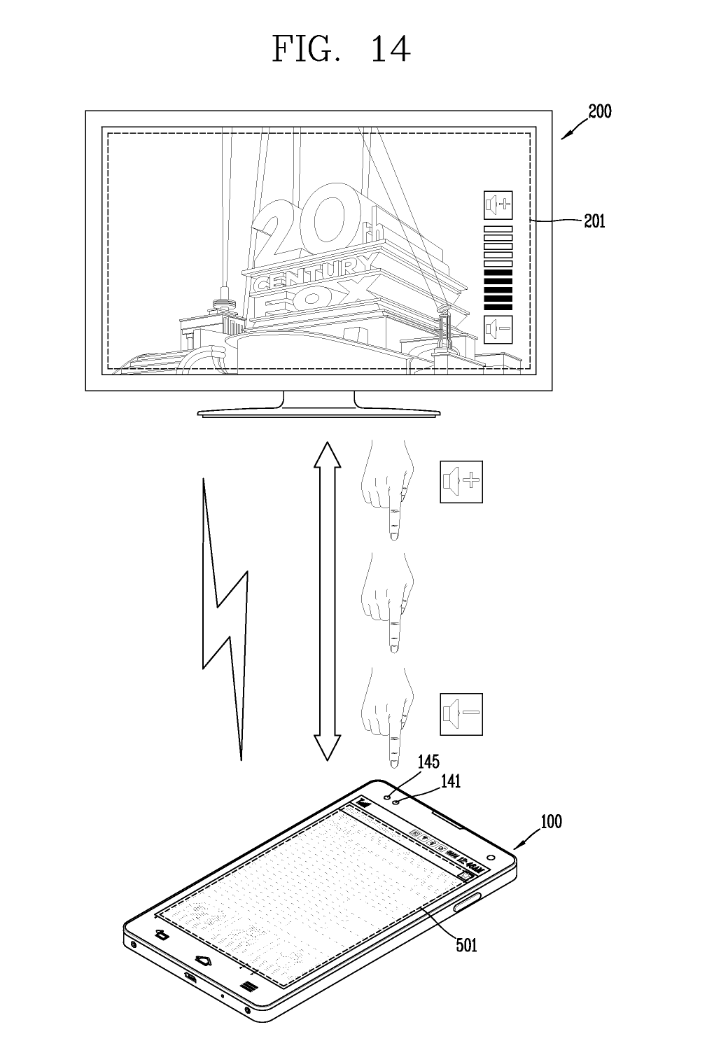

FIG. 14 is a diagram illustrating a process of controlling the image display apparatus according to another embodiment of the present invention.

As illustrated in FIG. 14, when the gesture sensor 145, the proximity sensor 141, and the proximity touch sensor sense an object in this sequence and then the gesture sensor 145 senses a predetermined gesture (for example, a shape of a human finger, the shape of the human hand, the palm of the human hand and the like), the controller 180 generates a first control signal for increasing a sound volume of the image display apparatus 200, transmits the generated first control signal to the image display apparatus 200, and thus increases the sound volume of the image display apparatus 200. When the gesture sensor 145 continues to sense a predetermined gesture (for example, the shape of the human finger, the shape of the human hand, the palm of the human hand, and the like) with the passage of time, the controller 180 transmits the first control signal for increasing the sound volume of the image display apparatus 200 to the image display apparatus, and thus continues to increase the sound volume of the image display apparatus 200 gradually. On the other hand, when the gesture sensor 145 no longer senses the predetermined gesture (for example, the shape of the human finger, the shape of the human hand, the palm of the human hand, and the like), the controller 180 stops transmitting the first control signal.

When the gesture sensor 145 and the proximity sensor 141 sense an object in this sequence (without the proximity touch sensor sensing the object) and then the gesture sensor 145 senses a predetermined gesture (for example, the shape of the human finger, the palm of the human hand, and the like), the controller 180 generates the first control signal for increasing the sound volume of the image display apparatus 200, transmits the generated first control signal to the image display apparatus 200, and thus may increase the sound volume of the image display apparatus 200.

On the other hand, when the proximity touch sensor and the proximity sensor 141 do not sense an object in this sequence (the object is in the non-sensed state) and then the gesture sensor 145 senses a predetermined gesture (for example, the shape of the human finger, the shape of the human hand, the palm of the human hand, and the like), the controller 180 generates a second control signal for decreasing the sound volume of the image display apparatus 200, transmits the generated second control signal to the image display apparatus 200, and thus decreases the sound volume of the image display apparatus 200. When the proximity touch sensor and the proximity sensor 141 do not sense an object in this sequence (the object is in the non-sensed state) and then the gesture sensor 145 continues to sense a predetermined gesture (for example, the shape of the human finger, the shape of the human hand, the palm of the human hand, and the like) with the passage of time, the controller 180 continues to transmit the second control signal for decreasing the sound volume of the image display apparatus 200 to the image display apparatus 200, and thus continues to decrease the sound volume of the image display apparatus 200 gradually. On the other hand, when the gesture sensor 145 no longer senses the predetermined gesture (for example, the shape of the human finger, the shape of the human hand, the palm of the human hand, and the like), the controller 180 stops transmitting the second control signal.

Therefore, in the mobile terminal and the method of controlling the mobile terminal according to the embodiment of the present invention, an external apparatus (for example, the image display apparatus) is controlled in a precise manner, based on the differences in the object-recognizable distance among the object detection sensors and on the gesture sensed through the gesture sensor.

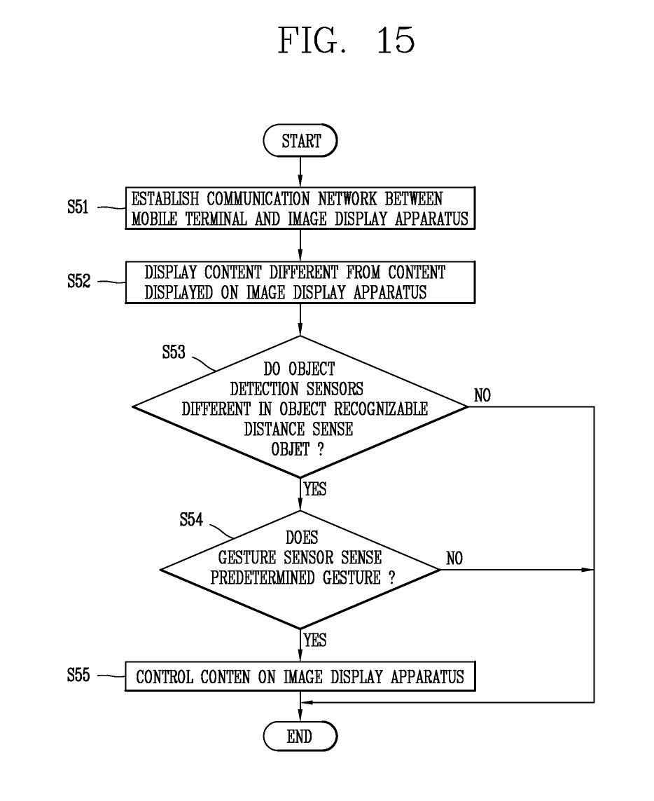

FIG. 15 is a flow chart illustrating a method of controlling the mobile terminal according to another embodiment.

First, the controller 180 establishes the communication network between the mobile terminal and the image display apparatus through the wireless communication unit 110 (for example, the short-range communication module 114) (S21).

The controller 180 establishes the communication network between the mobile terminal 100 and the image display apparatus 200 through the wireless communication unit 110 (for example, the short-range communication module 114) and displays the content (for example, the web page, the moving image, the music file, the photo file, and the like) requested by the user on the display unit 151. The controller 180 displays different content (for example, the web page) from the content (for example, the moving image) displayed on the image display apparatus 200 on the display unit 151 (S22).

The controller 180 determines whether the object detection sensors (for example, the proximity sensor 141, the gesture sensor 145, the proximity touch sensor, and the like) sense an object (S23). For example, the controller 180 determines whether the gesture sensor 145, the proximity sensor 141, and the proximity touch sensor sense the object in this sequence. The gesture sensor 145, the proximity sensor 141, and the proximity touch sensor are different in the maximum object-sensible distance.

When the gesture sensor 145, the proximity sensor 141, and the proximity touch sensor sense an object in this sequence, or when the proximity touch sensor, the proximity sensor 141, and the gesture sensor 145 sense the object in this sequence, the controller 180 of the mobile terminal 100 switches to a control mode for controlling content on the image display apparatus 200.

The controller 180 determines whether the gesture sensor 145 among the object detection sensors (for example, the proximity sensor 141, the gesture sensor 145, the proximity touch sensor, and the like) senses a predetermined gesture (for example, the human finger, the palm of the human hand, and the like) (S24).

For example, the controller 180 determines (detects) whether the gesture sensor 145, the proximity sensor 141, and the proximity touch sensor senses an object in this sequence and then the gesture sensor 145 senses a predetermined gesture (for example, the shape of the human finger, the shape of the human hand, and the like). Alternatively, the controller 180 determines (detects) whether the gesture sensor 145 and the proximity sensor 141 sense the object in this sequence (without the proximity touch sensor sensing the object) and then the gesture sensor 145 senses a predetermined gesture (for example, the shape of the human finger, the shape of the human hand, the palm of the human hand, and the like).

When the gesture sensor 145 among the object detection sensors (for example, the proximity sensor 141, the gesture sensor 145, the proximity touch sensor, and the like) senses a predetermined gesture (for example, the human finger, and the palm of the human hand, and the like), the controller 180 generates a control signal for controlling content on the image display apparatus 200, transmits the generated control signal to the image display apparatus 200, and thus controls the content on the image display apparatus 200 (S25).

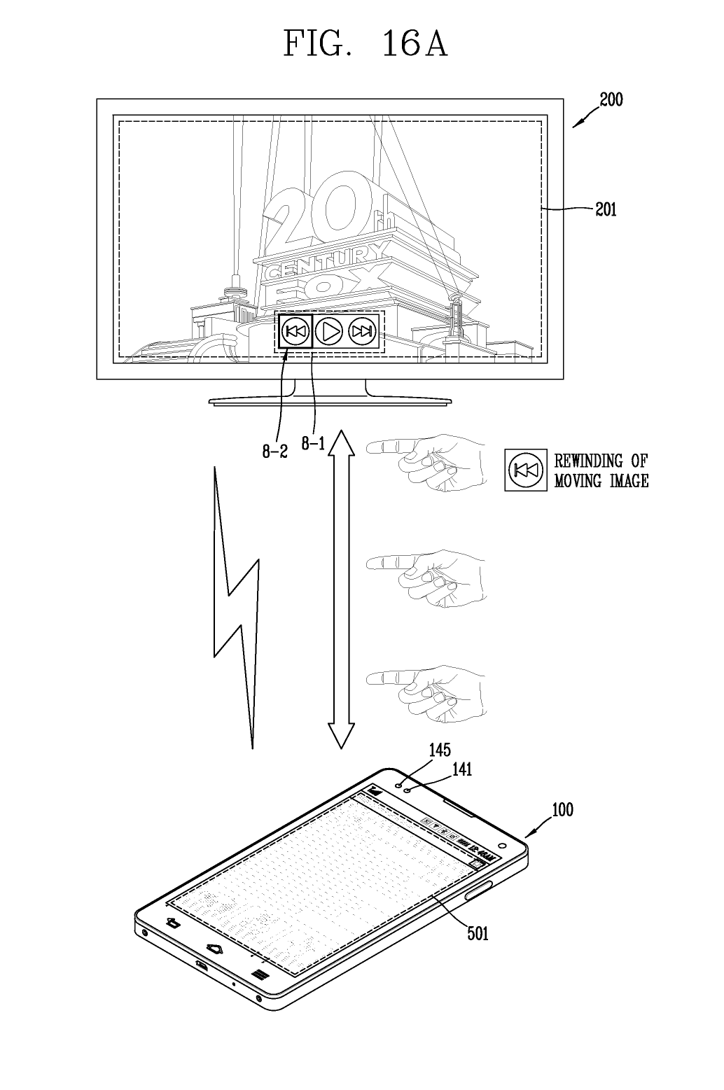

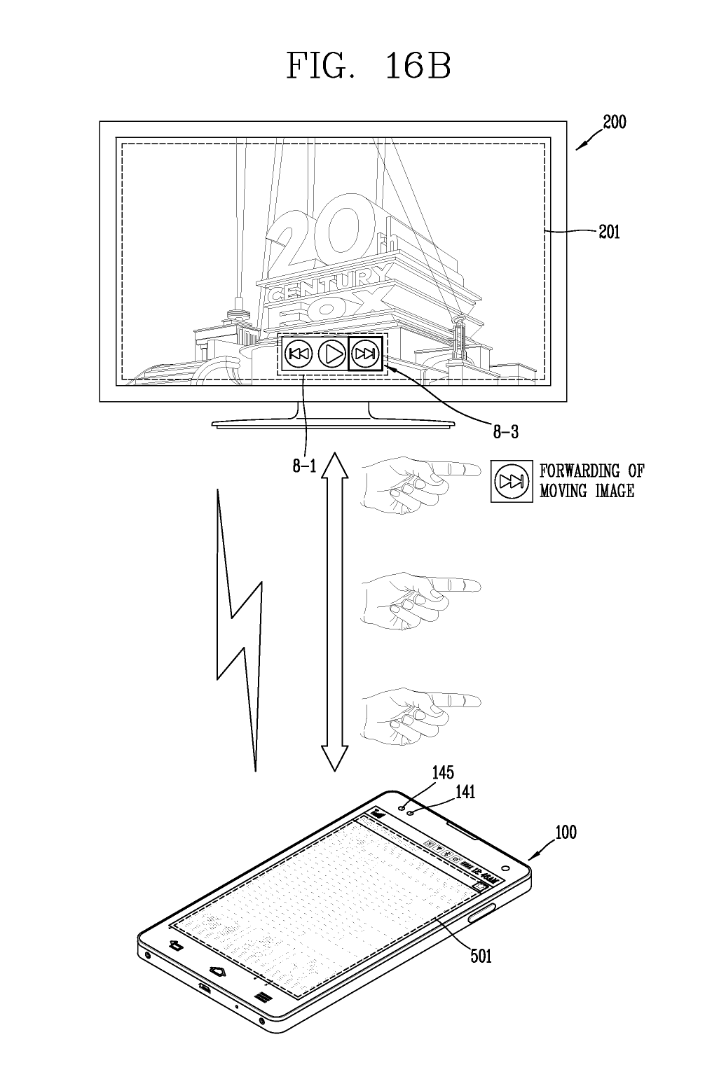

FIGS. 16A and 16B are diagrams illustrating a process of controlling content on the image display apparatus according to another embodiment of the present invention.

As illustrated in FIG. 16A, when the gesture sensor 145, the proximity sensor 141, and the proximity touch sensor sense an object in this sequence and then the gesture sensor 145 senses a predetermined gesture (for example, the gesture for rewinding the moving image), the controller 180 generates a control signal for rewinding the moving image on the image display apparatus 200, transmits the generated control signal to the image display apparatus 200, and thus rewinds the sound volume of the image display apparatus 200. At this point, based on the control signal for rewinding the moving image, the image display apparatus 200 displays control buttons 8-1 for controlling the moving image that is displayed on the image display apparatus 200, on the moving image, and activates a rewinding button 8-2 among the control buttons 8-1 and at the same time rewinds the moving image.

When the gesture sensor 145 continues to sense a predetermined gesture (for example, the gesture for rewinding the moving image) with the passage of time, the controller 180 continues to transmit the control signal to the image display apparatus in order to continuously rewind the moving image on the image display apparatus 200, and thus continues to perform the operation for rewinding the moving image on the image display apparatus 200. On the other hand, when the gesture sensor 145 no longer senses the predetermined gesture (for example, the gesture for rewinding the moving image), the controller 180 stops transmitting the control signal for rewinding the moving image on the image display apparatus 200.

When the gesture sensor 145 and the proximity sensor 141 sense an object in this sequence (without the proximity touch sensor sensing the object) and then the gesture sensor 145 senses a predetermined gesture (for example, the gesture for rewinding the moving image), the controller 180 generates the control signal for rewinding the moving image on the image display apparatus 200, transmits the generated signal to the image display apparatus 200, and thus rewinds the moving image on the image display apparatus 200.

On the other hand, when the proximity touch sensor and the proximity sensor 141 do not sense an object in this sequence (the object is in the non-sensed state) and then the gesture sensor 145 senses a predetermined gesture (for example, the gesture for rewinding the moving image), the controller 180 generates the control signal for rewinding the moving image on the image display apparatus 200, transmits the generated control signal to the image display apparatus 200, and thus rewinds the moving image on the image display apparatus 200.

When the proximity touch sensor and the proximity sensor 141 do not sense an object in this sequence (the object is not sensed), and then the gesture sensor 145 continues to sense a predetermined gesture (for example, the gesture for rewinding the moving image) with the passage of time, the controller 180 continues to the control signal for continuously rewinding the moving image on the image display apparatus 200 to the image display apparatus 200, and thus continues to operates the operation for rewinding the moving image on the image display apparatus 200.

On the other hand, when the gesture sensor 145 no longer senses the predetermined gesture (for example, the gesture for rewinding the moving image), the controller 180 stops transmitting the control signal for rewinding the moving image on the image display apparatus 200.

As illustrated in FIG. 16B, when the gesture sensor 145, the proximity sensor 141, and the proximity touch sensor sense an object in this sequence and then the gesture sensor 145 senses a predetermined gesture (for example, the gesture for forwarding the moving image), the controller 180 generates a control signal for forwarding the moving image on the image display apparatus 200, transmits the generated control signal to the image display apparatus 200, and thus performs the operation for forwarding the moving image on the image display apparatus 200. At this point, based on the control signal for forwarding the moving image, the image display apparatus 200 displays the control buttons 8-1 for controlling the moving image that is displayed on the image display apparatus 200, on the moving image, and activates a forwarding button 8-3 among the control buttons 8-1 and at the same time performs the operation for forwarding the moving image.

When the gesture sensor 145 continues to sense a predetermined gesture (for example, the gesture for forwarding the moving image) with the passage of time, the controller 180 continues to transmit the control signal to the image display apparatus in order to continuously forward the moving image on the image display apparatus 200, and thus continues to perform the operation for forwarding the moving image on the image display apparatus 200. On the other hand, when the gesture sensor 145 no longer senses the predetermined gesture (for example, the gesture for forwarding the moving image), the controller 180 stops transmitting the control signal for forwarding the moving image on the image display apparatus 200.

When the gesture sensor 145 and the proximity sensor 141 sense an object in this sequence (without the proximity touch sensor sensing the object) and then the gesture sensor 145 senses a predetermined gesture (for example, the gesture for forwarding he moving image), the controller 180 generates the control signal for forwarding the moving image on the image display apparatus 200, transmits the generated signal to the image display apparatus 200, and thus performs the operation for forwarding the moving image on the image display apparatus 200.

On the other hand, when the proximity touch sensor and the proximity sensor 141 do not sense an object in this sequence (the object is in the non-sensed state) and then the gesture sensor 145 senses a predetermined gesture (for example, the gesture for forwarding the moving image), the controller 180 generates the control signal for forwarding the moving image on the image display apparatus 200, transmits the generated control signal to the image display apparatus 200, and thus performs the operation for forwarding the moving image on the image display apparatus 200.

When the proximity touch sensor and the proximity sensor 141 do not sense an object in this sequence (the object is not sensed), and then the gesture sensor 145 continues to sense a predetermined gesture (for example, the gesture for forwarding the moving image) with the passage of time, the controller 180 continues to the control signal for continuously forwarding the moving image on the image display apparatus 200 to the image display apparatus 200, and thus continues to operates the operation for forwarding the moving image on the image display apparatus 200.

On the other hand, when the gesture sensor 145 no longer senses the predetermined gesture (for example, the gesture for forwarding the moving image), the controller 180 stops transmitting the control signal for forwarding the moving image on the image display apparatus 200.

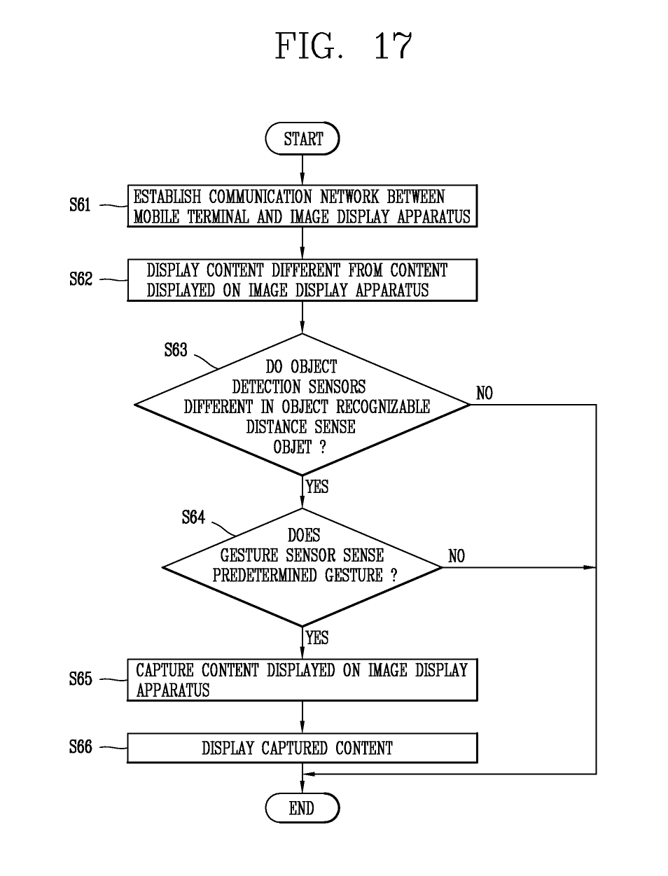

FIG. 17 is a flow chart illustrating a method of controlling the mobile terminal according to another embodiment.

First, the controller 180 establishes a communication network between the mobile terminal and the image display apparatus through the wireless communication unit 110 (for example, the short-range communication module 114) (S31).

The controller 180 establishes the communication network between the mobile terminal 100 and the image display apparatus 200 through the wireless communication unit 110 (for example, the short-range communication module 114) and displays the content (for example, the web page, the moving image, the music file, the photo file, and the like) requested by the user on the display unit 151. The controller 180 displays different content (for example, the web page) from the content (for example, the moving image) displayed on the image display apparatus 200 on the display unit 151 (S32).

The controller 180 determines whether the object detection sensors (for example, the proximity sensor 141, the gesture sensor 145, the proximity touch sensor, and the like) sense an object (S33). For example, the controller 180 determines whether the gesture sensor 145, the proximity sensor 141, and the proximity touch sensor sense the object in this sequence. The gesture sensor 145, the proximity sensor 141, and the proximity touch sensor are different in the maximum object-sensible distance.

When the gesture sensor 145, the proximity sensor 141, and the proximity touch sensor sense an object in this sequence, or when the proximity touch sensor, the proximity sensor 141, and the gesture sensor 145 sense the object in this sequence, the controller 180 of the mobile terminal 100 switches to the control mode for controlling the content on the image display apparatus 200.

The controller 180 determines whether the gesture sensor 145 among the object detection sensors (for example, the proximity sensor 141, the gesture sensor 145, the proximity touch sensor, and the like) senses a predetermined gesture (for example, the human finger, the palm of the human hand, and the like) (S34). For example, the controller 180 determines (detects) whether the gesture sensor 145, the proximity sensor 141, and the proximity touch sensor senses an object in this sequence and then the gesture sensor 145 senses a predetermined gesture (for example, a gesture for capturing an image displayed on the image display apparatus 200). Alternatively, the controller 180 determines (detects) whether the gesture sensor 145 and the proximity sensor 141 sense the object in this sequence (without the proximity touch sensor sensing the object) and then the gesture sensor 145 senses a predetermined gesture (for example, a gesture for capturing content that is displayed on the image display apparatus 200).

When the gesture sensor 145 among the object detection sensors (for example, the proximity sensor 141, the gesture sensor 145, the proximity touch sensor, and the like) senses a predetermined gesture (for example, the gesture for capturing the content that is displayed on the image display apparatus 200), the controller 180 generates a control signal for capturing (screen-capturing) the content (for example, the moving image) on the image display apparatus 200, transmits the generation control signal to the image display apparatus 200, and thus captures the content (for example, the moving image) on the image display apparatus 200 (S35). At this point, when capturing the moving image, the image display apparatus 200 reproduces the moving image continuously without stopping it.

The controller 180 displays the captured content on the display unit 151 (S36). The captured content includes a caption for the content (for example, the moving image) displayed on the image display apparatus 200, a voice file corresponding to the caption, and an image corresponding to the caption. When the user selects the caption displayed on the display unit 151, the controller 180 may run an application program (for example, a search program, a translation program, and the like) associated with the caption. The controller 180 may display on the display unit 151 an icon for outputting the voice file corresponding to the caption or the image corresponding to the caption, along with the caption for the content (for example, the moving image) displayed on the image display apparatus 200.

When the icon for outputting the voice file corresponding to the caption or the image corresponding to the caption is selected, the controller 180 may run an application program (for example, a music reproduction program or an image display program) for outputting the voice file or the image, or may run an application program (for example, a music editing program, or an image editing program) for editing the voice file or the image.

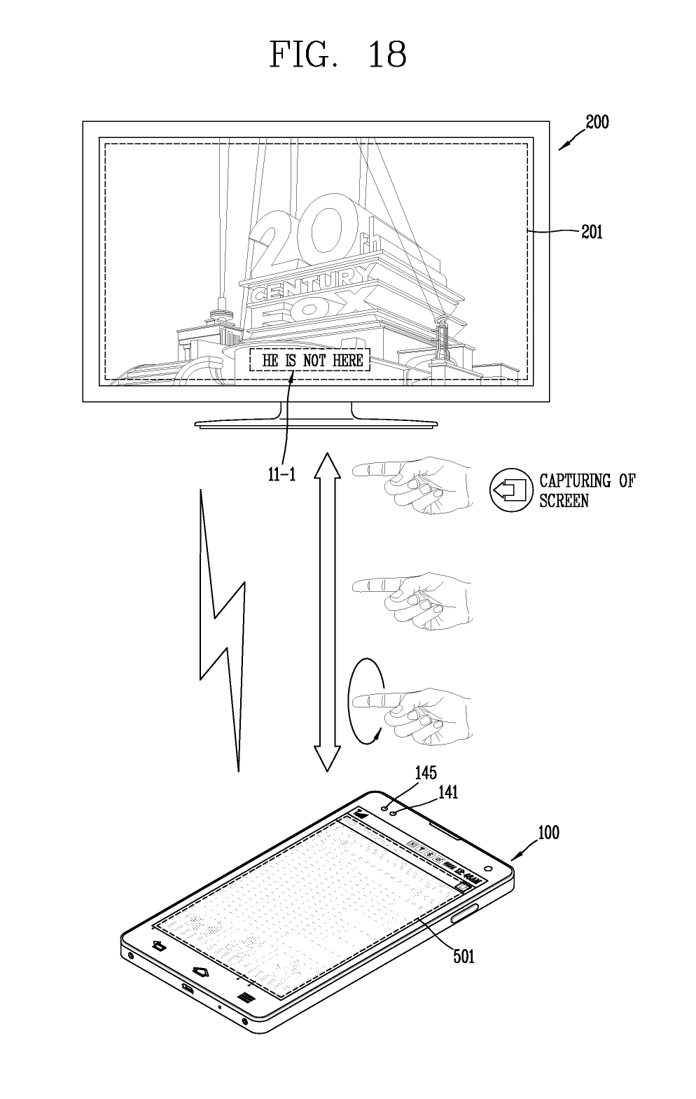

FIG. 18 is a diagram illustrating a process for capturing content on the image display apparatus according to another embodiment of the present invention.

As illustrated in FIG. 18, when the gesture sensor 145, the proximity sensor 141, and the proximity touch sensor sense an object in this sequence and then the gesture sensor 145 senses a predetermined gesture (for example, the gesture for capturing the moving image that is displayed on the image display apparatus 200), the controller 180 generates a control signal for capturing the moving image on the image display apparatus 200, transmits the generated control signal to the image display apparatus 200, and thus captures the moving image on the image display apparatus 200. At this point, based on the control signal for capturing the moving image, the image display apparatus 200 captures images 202 of the moving image that is displayed on the image capture apparatus 200, a caption 11-1 for the images 202, a voice file corresponding to the caption 11-1, and the like, and transmits these captured pieces of information to the controller 180. The controller 180 may store the images 202 of the moving image 202, the caption 11-1, the voice file, and the like in the storage unit 160 and may display them on the display unit 151.

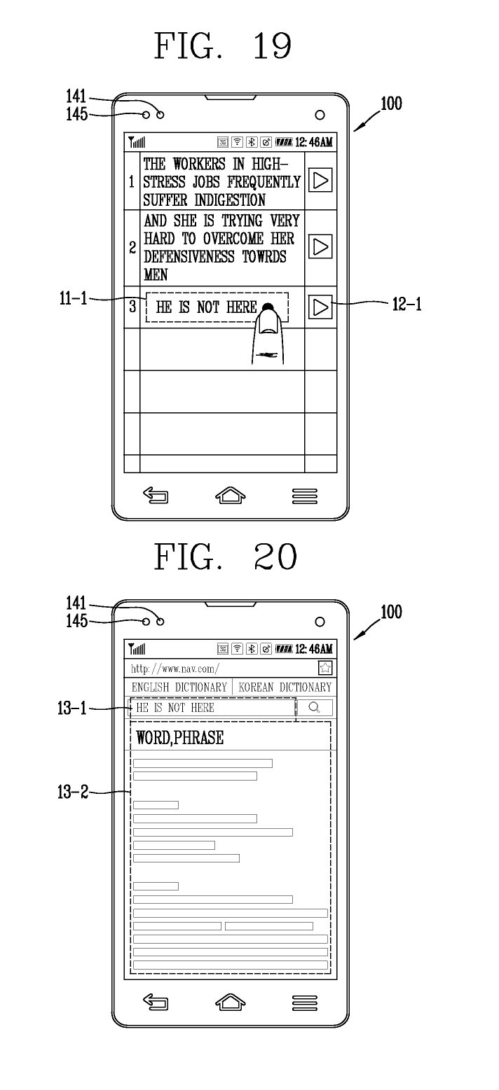

FIG. 19 is a diagram illustrating the captured content according to another embodiment of the present invention.

As illustrated in FIG. 19, the controller 180 receives the captured content (for example, the images 202 of the moving image 202, the caption 11-1, the voice file, and the like) from the image display apparatus 200, and displays on the display unit 151 the captured content that is received. The controller 180 lists up the captured content (for example, the images 202 of the moving image, the caption 11-1, the voice file, and the like), and displays icons 12-1 for outputting the voice file corresponding to the caption 11-1 or the images 202 corresponding to the caption 11-1 on the display unit 151, along with the caption 11-1 that are listed up.

When the icon 12-1 for outputting the voice file corresponding to the caption 11-1 or the image corresponding to the caption 11-1 is selected, the controller 180 may run an application program (for example, the music reproduction program or the image display program) for outputting the voice file or the image, or may run an application program (for example, the music editing program, or the image editing program) for editing the voice file or the image.

FIG. 20 is a diagram illustrating a process of running a program associated with captured content according to another embodiment of the present invention.

As illustrated in FIG. 20, when the user selects the caption 11-1 displayed on the display unit 151, the controller 180 runs an application program (for example, the search program, the translation program, and the like) associated with the caption 11-1, and thus displays a result 13-2 of a search relating to the caption 11-1 (for example, a result of translating the caption 11-1) on the display unit 151.

When the user selects the caption 11-1 displayed on the display unit 151, the controller 180 automatically displays the caption 11-1 on an input window 13-1 of the application program (for example, the search program, the translation program, and the like) associated with the caption 11-1.

Therefore, in the mobile terminal and the method of controlling the mobile terminal according to the embodiment of the present invention, the content on the external apparatus (for example, the image display apparatus) is captured in an easy, fast manner, based on the differences in the object-recognizable distance among the object detection sensors and on the gesture sensed through the gesture sensor.

Therefore, in the mobile terminal and the method of controlling the mobile terminal according to the embodiment of the present invention, the content on the external apparatus (for example, the image display apparatus) is captured based on the differences in the object-recognizable distance among the object detection sensors and on the gesture sensed through the gesture sensor, and the captured content is categorized (by the caption, the voice file, the image, and the like). Thus, the user can make good use of the captured content in an easy, fast manner.

As illustrated above, in the mobile terminal and the method of controlling the mobile terminal according to the embodiments of the present invention, the external apparatus (for example, the image display apparatus) is controlled in a precise manner, based on the differences in the object-recognizable distance among the object detection sensors and on the gesture sensed through the gesture sensor.

Therefore, with the mobile terminal and the method of controlling the mobile terminal according to the embodiments of the present invention, the user can control the content on the external apparatus (for example, the image display apparatus) while viewing the desired content through mobile terminal 100, by controlling the content on the external apparatus (for example, the image display apparatus) in a precise manner, based on the differences in the object-recognizable distance among the object detection sensors and on the gesture sensed through the gesture sensor.

In the mobile terminal and the method of controlling the mobile terminal according to the embodiments of the present invention, the content on the external apparatus (for example, the image display apparatus) is captured in an easy, fast manner, based on the differences in the object-recognizable distance among the object detection sensors and on the gesture sensed through the gesture sensor.

In the mobile terminal and the method controlling the mobile terminal according to the embodiments of the present invention, the content on the external apparatus (for example, the image display apparatus) is captured based on the differences in the object-recognizable distance among the object detection sensors and on the gesture sensed through the gesture sensor, and the captured content is categorized (by the caption, the voice file, the image, and the like). Thus, the user can make good use of the captured content in an easy, fast manner.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a display unit configured to receive a touch input as a first control command;
a gesture sensor;
a proximity touch sensor; and
a controller configured to receive a second control command different from the first control command when the gesture sensor and the proximity touch sensor sense an object in front of the display unit and the gesture sensor senses a predetermined first gesture,
wherein the gesture sensor and the proximity touch sensor has different object-recognizable distances.

2. The mobile terminal according to claim 1, wherein a first content and a second content are displayed on a first layer and a second layer of the display unit, respectively, and
wherein based on the second control command, the controller configured to activate the second layer.

3. The mobile terminal according to claim 2, wherein when the predetermined first gesture is sensed, the second layer is inactivated by controlling a transparency of the second content.

4. The mobile terminal according to claim 3, wherein when the proximity touch sensor senses the object and the gesture sensor senses the predetermined first gesture, the controller configured to set the transparency of the second content to the maximum value and thus inactivate the second layer.

5. The mobile terminal according to claim 2, wherein after the second layer is inactivated a drag operation is sensed, the controller configured to display the first content on the first layer.

6. The mobile terminal according to claim 2, wherein when at least one of the gesture sensor and the proximity touch sensor do not sense the object, and then the gesture sensor senses the predetermined first gesture, the controller sets a transparency of the second content to the maximum value and thus inactivate the second layer.

7. The mobile terminal according to claim 2, wherein when a third content is displayed on a third layer of the display unit, at lease one of the gesture sensor and the proximity touch sensor do not sense the object, and then the gesture sensor senses the predetermined first gesture, the controller configured to set a transparency of the second content and a transparency of the third content to the maximum value and thus inactivate the second layer and third layer.

8. The mobile terminal according to claim 2, wherein when the gesture sensor and the proximity touch sensor sense the object, and then the gesture sensor senses the predetermined first gesture, the controller configured to control the second content.

9. The mobile terminal according to claim 1, further comprising:
a communication unit configured to establish a communication network between the mobile terminal and an image display apparatus,
wherein based on the second control command, the controller configured to generate a first control signal for controlling the image display apparatus, and transmits the first control signal to the image display apparatus over the communication network.

10. The mobile terminal according to claim 1, wherein a maximum object-recognizable distance for the gesture sensor is greater than those for the proximity touch sensor

11. A method of controlling a terminal, comprising:
receiving, by a display unit, a touch input as a first control command;
sensing, by a gesture sensor and a proximity touch sensor, an object in front of the display unit;
sensing, by the gesture sensor, a predetermined first gesture; and
receiving a second control command different from the first control command, and
wherein the gesture sensor and the proximity touch sensor have different object-recognizable distances.

12. The method of claim 11, further comprising:
displaying a first content and a second content on a first layer and a second layer of the display unit, respectively; and
activating the second layer based on the second control command.

13. The method of claim 12, further comprising:
inactivating the second layer by controlling transparency of the second content when the predetermined first gesture is sensed.

14. The method of claim 13, further comprising:
setting the transparency of the second content to the maximum value and thus inactivating the second layer when the proximity touch sensor senses the object and the gesture sensor senses the predetermined first gesture.

15. The method of claim 12, further comprising:
displaying the first content on the first layer when the second layer is inactivated and a drag operation is sensed.

16. The method of claim 12, further comprising:
is setting transparency of the second content to the maximum value and thus inactivating the second layer when at least one of the gesture sensor and the proximity touch sensor do not sense the object and then the gesture sensor senses the predetermined first gesture.

17. The method of claim 12, further comprising:
displaying a third content on a third layer of the display unit;
setting transparency of the second content and transparency of the third content to the maximum values, respectively, and thus inactivating the second layer and the third layer when at lease one of the gesture sensor and the proximity touch sensor does not sense the object and then the gesture sensor senses the predetermined first gesture.

18. The method of claim 12, further comprising:
controlling the second content when the gesture sensor and the proximity touch sensor sense the object and then the gesture sensor senses the predetermined first gesture.

19. The method of claim 11, further comprising:
establishing, by a communication unit, a communication network between the mobile terminal and an image display apparatus;
generating a first control signal for controlling the image display apparatus based on the second control command; and
transmitting the first control signal to the image display apparatus over the communication network

20. The method of claim 11, wherein a maximum object-recognizable is distance for the gesture sensor is greater than that for the proximity touch sensor.
